(19) United States
(12) Patent Application Publication
(10) Pub. No.: US 2025/0284965 A1
(43) Pub. Date: Sep. 11, 2025

(54) SYSTEM AND METHOD FOR OFFLINE DATA-DRIVEN DISCOVERY AND DISTILLATION FOR SEQUENTIAL DECISION-MAKING WITH LARGE LANGUAGE MODELS

(71) Applicant: JPMorgan Chase Bank, N.A., New York, NY (US)

(72) Inventors: Yuchen XIAO, Jersey City, NJ (US); Yanchao SUN, Jersey City, NJ (US); Mengda XU, Jersey City, NJ (US); Udari MADHUSHANI SEHWAG, Jersey City, NJ (US); Jared VANN, London (GB); Deepeka GARG, London (GB); Sumitra GANESH, Short Hills, NJ (US)

(73) Assignee: JPMorgan Chase Bank, N.A., New York, NY (US)

(21) Appl. No.: 18/601,297

(22) Filed: Mar. 11, 2024

(51) Int. Cl. G06N 3/0895

(52) U.S. Cl. CPC G06N 3/0895

(57) ABSTRACT

A method and system for performing a task requiring a plurality of sequential decision-making operations by an autonomous agent are disclosed. The method includes acquiring a portion of offline data from a database, and discovering a set of separate skills. The method further includes segmenting the offline data and segmenting the offline data according to skill, and abstracting the segmented offline data into reusable functions. From the abstracted reusable functions, distilling primitives for each skill and distilling reusable tips in various functions. Modifying skill based text-based and code-based policies for augmenting the autonomous agent, and processing a task requiring a set of sequential decision-making operations using the augmented autonomous agents.

### TECHNICAL FIELD

This disclosure generally relates to performing offline data-driven discovery and distillation processes using Large Language Models (LLMs). Further, the present disclosure also relates to performing sequential decision making with LLMs, utilizing the outcomes from the discovery and distillation stages.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Large language models (LLMs) have exhibited promising performance in solving sequential decision-making problems. By imitating few-shot examples provided in the prompts (i.e., in-context learning), an LLM agent may be able to interact with an external environment and complete given tasks without additional training. More specifically, one-step text generation such as question and answering may be able to be performed based on the few-shot examples.

As illustrated in FIG. 14, a LLM Agent, which leverages its in-context learning capability through the few-shot examples given in the base prompt to sequentially interact with an external environment by receiving observations and performing actions in a textual format to accomplish a task.

However, such few-shot examples may be insufficient to generate higher quality solutions for complex and long-horizon tasks as complexity increases exponentially with the interaction horizon, such that large amount of data or demonstrations may be necessary for an autonomous agent to adequately understand the environment dynamics, especially for heterogeneous real-world environments and tasks, where cross-task generalizability may be important. For example, the existing LLM agent may be listed to online task-specific reasoning and action, online task-specific reflection from trial and error, constrained to a number of examples due to limited context length, and require extensive finetuning at the cost of high expenditure of technical resources (e.g., high utilization of CPU, memory and other resources).

Further, the in-context learning ability may be constrained by the limited context window of an LLM. Accordingly, even if many demonstrations were available, it may still be difficult to prompt LLMs with sufficient examples.

### SUMMARY

According to an aspect of the present disclosure, a method for performing a task requiring a plurality of sequential decision-making operations by an autonomous agent is provided. The method includes acquiring, by a processor and from a database, a portion of offline data; identifying, by the processor and from the portion of the offline data, skills data corresponding to a plurality of skills; segmenting, by the processor, the skills data into a plurality of skill oriented sub-trajectories corresponding to the plurality of skills; abstracting, by the processor, the plurality of skills into a plurality of reusable functions; storing, by the processor and in a memory, the plurality of reusable functions; discovering, from the memory, one or more primitives for each of the plurality of reusable functions; identifying, by the processor and from the portion of the offline data acquired, at least one successfully completed task interaction and at least one failed task interaction; generating, by the processor, at least one or more distilled tips based on the at least one successfully completed task interaction and the at least one failed task interaction; modifying, by the processor, a skill-conditioned text based policy and a skill-conditioned code-based policy; augmenting, by the processor and using the modified skill-conditioned text based policy and the modified skill-conditioned code-based policy, the autonomous agent; receiving, by the processor for execution by the autonomous agent, a new task requiring a plurality of sequential decision-making operations by the autonomous agent; and completing, using the augmented autonomous agent, a new task requiring a plurality of sequential decision-making operations.

According to another aspect of the present disclosure, the completing of the new task includes: dividing, by the augmented autonomous agent, the new task into a plurality of sub-tasks for execution in sequential order; identifying, by the augmented autonomous agent and for each of the plurality of sub-tasks, an environment; calling, by the augmented autonomous agent and among the modified skill-conditioned text based policy and the modified skill-conditioned code-based policy, at least one skill conditioned policy corresponding to a sub-task; performing, by the augmented autonomous agent, at least one primitive observation for the environment corresponding to the sub-task; and determining, by the augmented autonomous agent, at least one primitive action for the environment corresponding to the sub-task.

According to another aspect of the present disclosure, the method further includes determining, by the augmented autonomous agent, whether the sub-task is a last sub-task among the plurality of sub-tasks; and when the sub-task is determined not to be the last sub-task, processing another sub-task that sequentially follows the sub-task.

According to yet another aspect of the present disclosure, the method further includes determining, by the augmented autonomous agent, whether the sub-task is a last sub-task among the plurality of sub-tasks; and when the sub-task is determined to be the last sub-task: combining, by the augmented autonomous agent, the at least one primitive observation and the at least one primitive action; and outputting, by the augmented autonomous agent, an output including a combination of the at least one primitive observation and the at least one primitive action.

According to another aspect of the present disclosure, the autonomous agent is a large language model.

According to a further aspect of the present disclosure, training of the autonomous agent is not required.

According to yet another aspect of the present disclosure, the offline data is a historical interaction log.

According to a further aspect of the present disclosure, the historical interaction log is with a human agent.

According to another aspect of the present disclosure, the offline data includes both a successfully completed task transaction and a failed task transaction.

According to a further aspect of the present disclosure, one or more of the plurality of reusable functions are executed by one or more skill-specific autonomous agents.

According to a further aspect of the present disclosure, at least one of the one or more skill-specific autonomous agents is a large language model agent.

According to a further aspect of the present disclosure, the new task is completed without fine tuning the augmented autonomous agent.

According to a further aspect of the present disclosure, the output is provided as a text prompt.

According to a further aspect of the present disclosure, the one or more of the plurality of reusable functions includes a find function, a take function, a put function, a cool function, a heat function, a use function and a clean function.

According to a further aspect of the present disclosure, the at least one or more distilled tips includes a tip that indicates what action is preferred under different circumstances.

According to a further aspect of the present disclosure, the at least one or more distilled tips includes a tip that enhances a desired behavior.

According to a further aspect of the present disclosure, the at least one or more distilled tips includes a tip that discourages an undesired behavior.

According to a further aspect of the present disclosure, the at least one primitive action includes an action with a place holder for a subject.

According to an aspect of the present disclosure, a system for performing a task requiring a plurality of sequential decision-making operations by an autonomous agent is provided. The system includes a memory, a display and a processor. The system is configured to perform: acquiring, from a database, a portion of offline data; identifying, from the portion of the offline data, skills data corresponding to a plurality of skills; segmenting the skills data into a plurality of skill oriented sub-trajectories corresponding to the plurality of skills; abstracting the plurality of skills into a plurality of reusable functions; storing the plurality of reusable functions; discovering one or more primitives for each of the plurality of reusable functions; identifying, from the portion of the offline data acquired, at least one successfully completed task interaction and at least one failed task interaction; generating at least one or more distilled tips based on the at least one successfully completed task interaction and the at least one failed task interaction; modifying a skill-conditioned text based policy and a skill-conditioned code-based policy; augmenting, using the modified skill-conditioned text based policy and the modified skill-conditioned code-based policy, the autonomous agent; receiving, for execution by the autonomous agent, a new task requiring a plurality of sequential decision-making operations by the autonomous agent; and completing, using the augmented autonomous agent, a new task requiring a plurality of sequential decision-making operations.

According to another aspect of the present disclosure, a non-transitory computer readable storage medium that stores a computer program for performing a task requiring a plurality of sequential decision-making operations by an autonomous agent is provided. The computer program, when executed by a processor, causes a system to perform multiple processes including: acquiring, from a database, a portion of offline data; identifying, from the portion of the offline data, skills data corresponding to a plurality of skills; segmenting the skills data into a plurality of skill oriented sub-trajectories corresponding to the plurality of skills; abstracting the plurality of skills into a plurality of reusable functions; storing the plurality of reusable functions; discovering one or more primitives for each of the plurality of reusable functions; identifying, from the portion of the offline data acquired, at least one successfully completed task interaction and at least one failed task interaction; generating at least one or more distilled tips based on the at least one successfully completed task interaction and the at least one failed task interaction; modifying a skill-conditioned text based policy and a skill-conditioned code-based policy; augmenting, using the modified skill-conditioned text based policy and the modified skill-conditioned code-based policy, the autonomous agent; receiving, for execution by the autonomous agent, a new task requiring a plurality of sequential decision-making operations by the autonomous agent; and completing, using the augmented autonomous agent, a new task requiring a plurality of sequential decision-making operations.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an Offline Data-driven Discovery and Distillation (O3D) system for sequential decision-making with large language models in accordance with an exemplary embodiment.

FIG. 2 illustrates an exemplary diagram of a network environment with an O3D system for sequential decision-making with large language models in accordance with an exemplary embodiment.

FIG. 3 illustrates a system diagram for implementing an O3D system for sequential decision-making with large language models in accordance with an exemplary embodiment.

FIGS. 4A-4D illustrate stages of an O3D platform in accordance with an exemplary embodiment.

FIG. 5 illustrates a method for constructing a skill-conditioned policy using an O3D platform in accordance with an exemplary embodiment.

FIG. 6 illustrates a method for providing a prompt for performing a task using a skill-conditioned policy in accordance with an exemplary embodiment.

FIG. 7 illustrates prompts for base policy and text-based skill-conditioned policy for hierarchical policy execution in accordance with an exemplary embodiment.

FIG. 8 illustrates an algorithm for policy learning with O3D in accordance with an exemplary embodiment.

FIG. 9 illustrates algorithms for text-based policy and code-base policy in accordance with an exemplary embodiment.

FIG. 10 illustrates results for comparative testing between different methods for performing tasks in two sequential decision-making benchmarks in accordance with an exemplary embodiment.

FIG. 11 illustrates examples of discovered skills with primitives and distilled knowledge under a sequential decision-making benchmark in accordance with an exemplary embodiment.

FIG. 12 illustrates a comparison of success rates with three variants of O3D against a baseline method in accordance with an exemplary embodiment.

FIG. 13 illustrates a comparison on averaged success rate over LLM models between using tips distilled via contrastive and non-contrastive (NC) methods in accordance with an exemplary embodiment.

FIG. 14 illustrates a conventional large language model performing in-context learning and performing a single step task.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

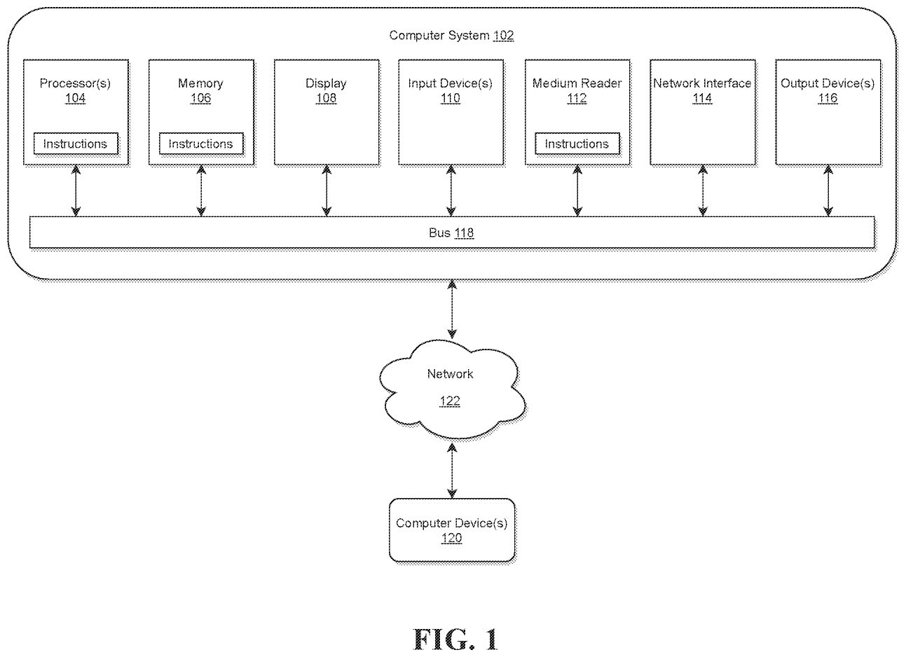

FIG. 1 illustrates a computer system for implementing an Offline Data-driven Discovery and Distillation (O3D) system for sequential decision-making with large language models in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

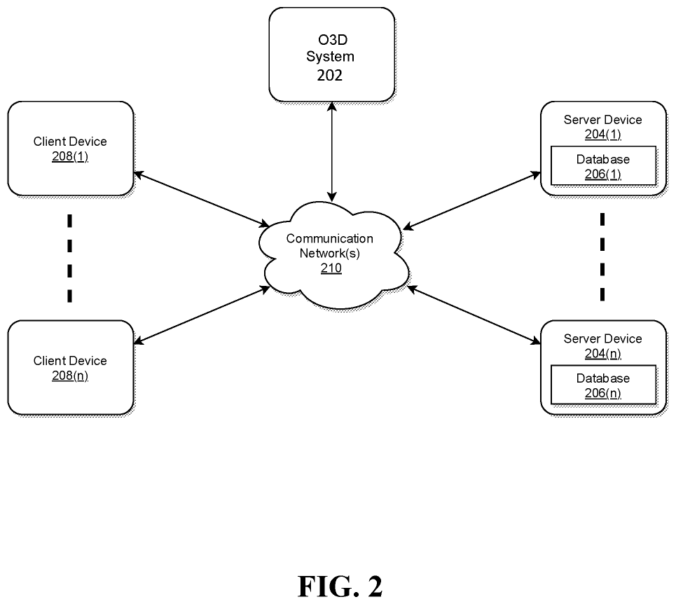

FIG. 2 illustrates an exemplary diagram of a network environment with an O3D system for sequential decision-making with large language models in accordance with an exemplary embodiment.

An O3D system 202 may be implemented with one or more computer systems similar to the computer system 102 as described with respect to FIG. 1.

The O3D system 202 may store one or more applications that can include executable instructions that, when executed by the O3D system 202, cause the O3D system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the O3D system 202 itself, may be located in virtual server(s) running in a cloud-based computing environment rather than being tied to one or more specific physical network computing devices. Also, the application(s) may be running in one or more virtual machines (VMs) executing on the O3D system 202. Additionally, in one or more embodiments of this technology, virtual machine(s) running on the O3D system 202 may be managed or supervised by a hypervisor.

In the network environment 200 of FIG. 2, the O3D system 202 is coupled to a plurality of server devices 204(1)-204(n) that hosts a plurality of databases 206(1)-206 (n), and also to a plurality of client devices 208(1)-208(n) via communication network(s) 210. According to exemplary aspects, databases 206(1)-206 (n) may be configured to store data that relates to distributed ledgers, blockchains, user account identifiers, biller account identifiers, and payment provider identifiers. A communication interface of the O3D system 202, such as the network interface 114 of the computer system 102 of FIG. 1, operatively couples and communicates between the O3D system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the O3D system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The O3D system 202 may be a standalone device or integrated with one or more other devices or apparatuses, such as one or more of the server devices 204(1)-204(n), for example. In one particular example, the O3D system 202 may be hosted by one of the server devices 204(1)-204(n), and other arrangements are also possible. Moreover, one or more of the devices of the O3D system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the O3D system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206 (n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the O3D system 202 that may efficiently provide a platform for implementing a cloud native O3D system module, but the disclosure is not limited thereto.

The client devices 208(1)-208(n) may run interface applications, such as standard web browsers or standalone client applications, which may provide an interface to communicate with the O3D system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the O3D system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the O3D system 202, the server devices 204(1)-204(n), or the client devices 208(1)-208(n), for example, may be configured to operate as virtual instances on the same physical machine. For example, one or more of the O3D system 202, the server devices 204(1)-204(n), or the client devices 208(1)-208(n) may operate on the same physical device rather than as separate devices communicating through communication network(s) 210. Additionally, there may be more or fewer O3D system 202, server devices 204(1)-204(n), or client devices 208(1)-208(n) than illustrated in FIG. 2. According to exemplary embodiments, the O3D system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

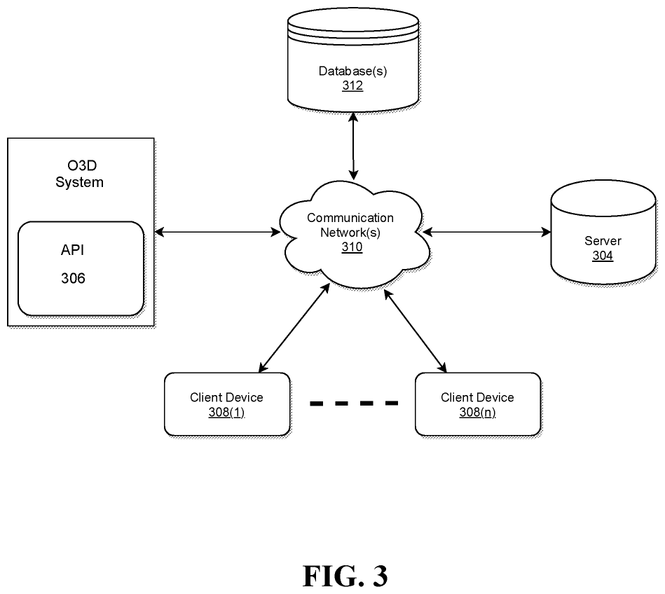

FIG. 3 illustrates a system diagram for implementing an O3D system for sequential decision-making with large language models in accordance with an exemplary embodiment.

As illustrated in FIG. 3, the system 300 may include an O3D system 302 within which a group of API modules 306 is embedded, a server 304, a database(s) 312, a plurality of client devices 308(1) . . . 308(n), and a communication network 310.

According to exemplary embodiments, the O3D system 302 including the API modules 306 may be connected to the server 304, and the database(s) 312 via the communication network 310. Although there is only one database that has been illustrated, the disclosure is not limited thereto. Any number of databases may be utilized. The O3D system 302 may also be connected to the plurality of client devices 308(1) . . . 308(n) via the communication network 310, but the disclosure is not limited thereto.

According to exemplary embodiment, the O3D system 302 is described and shown in FIG. 3 as including the API modules 306, although it may include other rules, policies, modules, databases, or applications, for example. According to exemplary embodiments, the database(s) 312 may be embedded within the O3D system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable O3D system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the O3D system 302. In this regard, the plurality of client devices 308(1) . . . 308(n) may be “clients” of the O3D system 302 and are described herein as such. Nevertheless, it is to be known and understood that the plurality of client devices 308(1) 308 (n) need not necessarily be “clients” of the O3D system 302, or any entity described in association therewith herein. Any additional or alternative relationship may exist between either or both of the plurality of client devices 308(1) . . . 308(n) and the O3D system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the O3D system 302 via broadband or cellular communication. Of course, these embodiments are merely exemplary and are not limiting or exhaustive.

The client devices 308(1) . . . 308(n) may be the same or similar to any one of the client devices 208(1)-208(n) as described with respect to FIG. 2, including any features or combination of features described with respect thereto. The O3D system 302 may be the same or similar to the O3D system 202 as described with respect to FIG. 2, including any features or combination of features described with respect thereto.

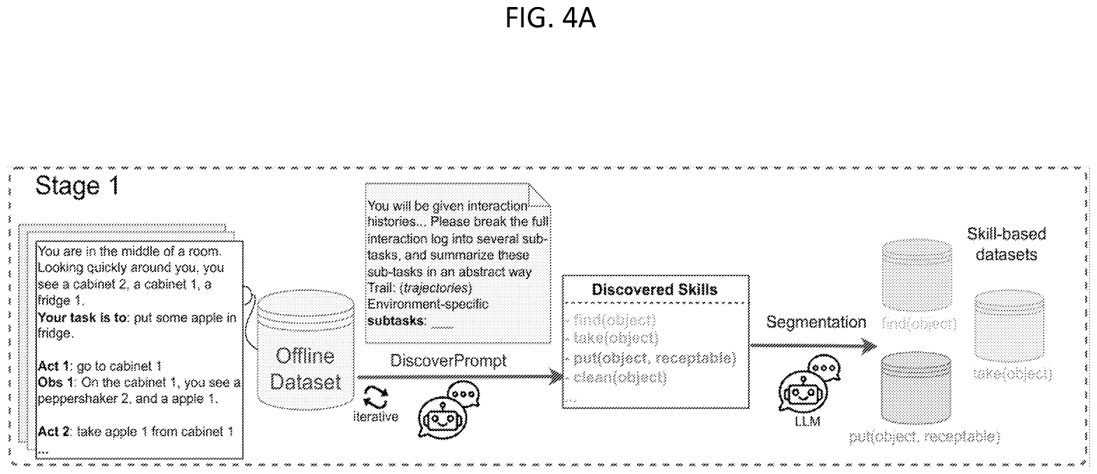

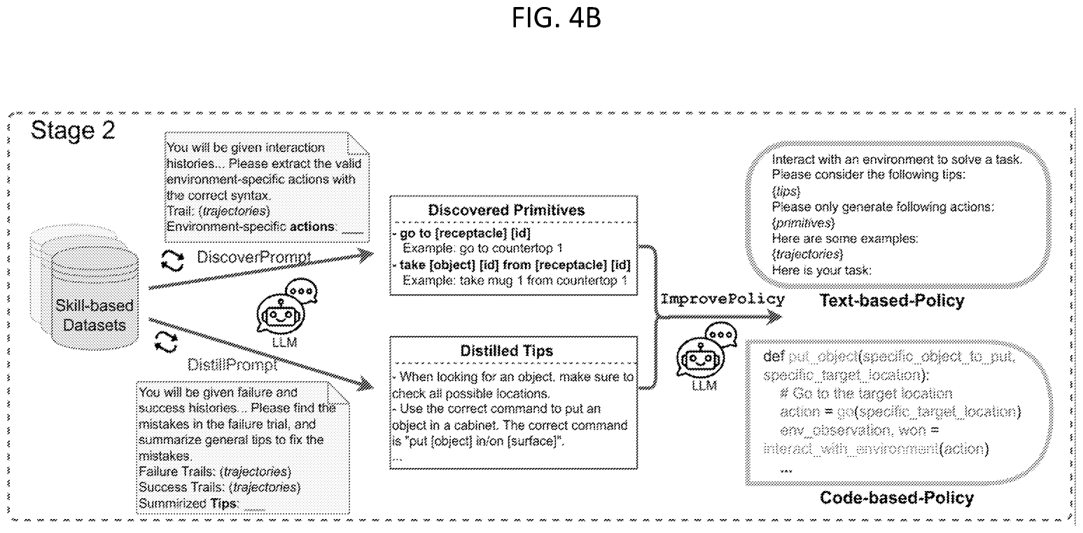

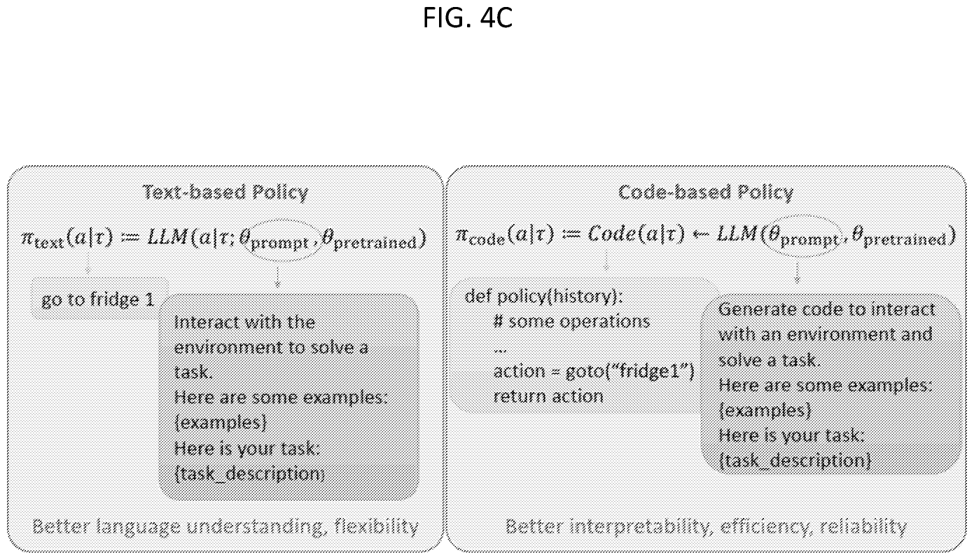

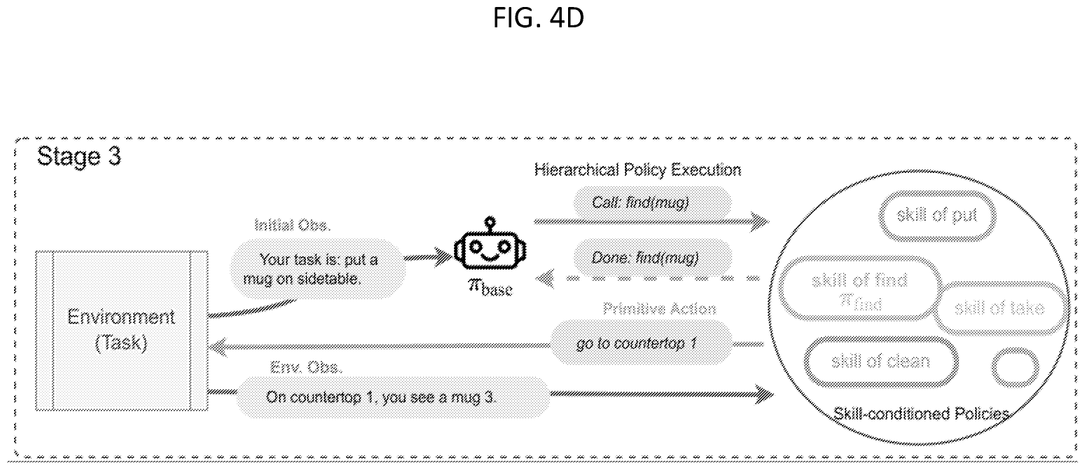

FIGS. 4A-4D illustrate stages of an O3D platform in accordance with an exemplary embodiment.

According to exemplary aspects, the presently disclosed system and method are directed to providing an offline learning framework that utilizes offline data at scale to facilitate the in-context learning performance of LLM agents. In an example, offline data utilized may include logs of human interactions or other similar data. For the offline learning framework, LLM-powered policies may be formally defined with both text-based approaches and code-based approaches. Subsequently, an O3D framework may be applied to improve LLM-powered policies without requiring finetuning.

In various real-world decision-making systems, interaction log from various users may be available, including experts who may successfully perform a given task as well as non-experts who may fail and make various mistakes. In other words, both successfully completed examples (i.e., good examples) and failed examples (i.e., bad examples) may be available in the stored interaction logs. According to exemplary aspects, the O3D framework may be configured to learn a policy to be utilized in the O3D system by utilizing the offline dataset to learn the base prompt, but having the model weights, Opret, fixed.

According to exemplary aspects, interaction logs from others performing a task may be utilized by LLMs to understand environments corresponding to a task and learn to complete similar tasks. LLMs may utilize a learning paradigm analogous to behavior cloning, which may utilize few expert demonstrations to imitate how experts react to certain scenarios, with key differences. Conventional behavior cloning suffers from distribution shift between expert demonstrations and the agent's own online interactions, especially when the expert dataset is small and not representative of all scenarios in the domain. Although conventional LLMs may be powerful at interpolating and generalizing with pre-trained language understanding ability, their fixed context length only allows a limited number of expert demonstrations, rendering it difficult to fully or more deeply understand external decision-making environment with specific dynamics and requirements. That is, even when there exists a rich and diverse offline dataset, in-context behavior cloning is only able to utilize a small subset of the data, leading to sub-optimal policies. In order to overcome such technical limitation, aspects of the present disclosure introduce an offline learning framework for LLM-powered policies, including both text-based policy and code-based policy as specified below.

As illustrated in FIGS. 4A-4D, O3D is composed of three stages. First stage is exemplarily illustrated in FIG. 4A, the second stage is exemplarily illustrated in FIGS. 4B-4C, and the third stage is exemplarily illustrated in FIG. 4D.

According to exemplary aspects, all three stages may be based on querying LLMs and iterating over existing text or code based policies. As a result, O3D framework is capable of learning better policies from offline dataset at scale without requiring any model finetuning, which is conventionally performed. Accordingly, production ready machine learning product may be provided more efficiently and quickly with reduce utilization of technical resources.

According to exemplary aspects, the first stage may aim to discover reusable skills by segmenting the offline interaction trajectories. More specifically, the first stage may enable LLM to discover and abstract reusable skills from offline datasets, potentially from diverse tasks.

Many real-world decision-making processes may require a number of steps to complete a task. For example, controlling a robot to pass several obstacles and navigate to the door. Accordingly, the number of steps required for completing a task results in two challenges for LLM-powered agents. First, the limited context length may not be enough to contain the few-shot demonstration and online interaction history. Second, the language model may lose track of its goal and fail to pay attention to the more important information. To mitigate this issue, a hierarchical policy learning framework may iteratively extract skills from interaction logs with primitive-level executions.

### First Stage

According to exemplary aspects, the first stage may be directed to discovering a set of skills. As exemplarily illustrated in FIG. 4A, the first stage or the discovery process iterates over the offline trajectories using a discover prompt for separating out interactions according to one or more skills. More specifically, the LLMs may be asked to divide the interaction histories into skill-oriented sub-trajectories, and abstract the skills in function forms. According to exemplary aspects, abstracted skill functions may include, without limitation, find(object), take(object), clean(object), heat(object), cool(object), use(object), put(object, receptacle) and the like. According to exemplary aspects, the abstracted skill functions may be reusable across various tasks.

As illustrated in FIG. 4A, an LLM agent may perform iterative processing using offline data, such as logs of human interactions. According to exemplary aspects, the offline data may not be pre-filtered and may include both good examples and both examples. During the iterative processing by the LLM agent, the LLM agent may divide the offline data or the interaction histories into skill-oriented sub-trajectories, and abstract the skills in function forms. As exemplarily illustrated in FIG. 4A, the discovered skills may include a find object, a take object, a clean object and a put object and/or receptacle. Each skill-based dataset includes the corresponding skill-oriented sub-trajectories.

### Second Stage

According to exemplary aspects, the second stage may produce and optimize corresponding skill-conditioned policies. More specifically, the second stage subsequently conducts skill-conditioned policy improvement by distilling knowledge from offline data. More specifically, the second stage aims to learn a skill-based policy for each discovered skill, through iterative discovery and primitives and iterative policy improvement with knowledge distillation. Such knowledge may be generalizable to tolerate the distribution shift between offline data and online interactions, which was unattainable in the conventional LLM agent systems.

According to exemplary aspects, the second stage is directed to distilling generalizable knowledge from offline datasets, such that the knowledge may improve a policy's performance between offline data and online interactions. For example, select types of knowledge may be distilled from the segmented skill-based trajectories in an iterative process. Such operations may lead to improved skill-conditioned policies. According to exemplary aspects, the select types of knowledge may include, without limitation, primitive actions, policy improvement tips with trajectory contrasting, and the like.

As noted above, distillation of primitive actions may be a type of knowledge. According to exemplary aspects, a common mistake of LLM-powered agents is hallucination. In an example, hallucination may refer to when an LLM-powered agent outputs actions that are not valid in its respective environment. To ensure effective usage of LLM in decision-making applications, space of actions may be specified in the form of natural language or code. Conventionally, available primitive functions may be required to be manually defined, which necessitates specific domain knowledge by a person. In contrast to the conventional practice, exemplary aspects of the present disclosure performs distillation of primitive actions or functions from the offline interaction data with LLM, which may be easy to scale up and automate the practical application.

As illustrated in FIG. 4B, both the discovery operation and the distillation operation may be iteratively performed based on the abstracted skill functions, each of the abstracted skill function including corresponding skill-based datasets. During the discovery operation, one or more primitives are identified based on the stored skill-based datasets. For example, discovered primitives may include “go to [receptacle] [id]” and “take [object] [id] from [receptacle] [id]” as environment-specific actions as illustrated in FIG. 4B. For example, an environment-specific action of “go to [receptacle] [id]” may include an example of go to countertop 1, and an environment-specific action of “take [object] [id] from [receptacle] [id]” may include an example of take mug 1 from countertop 1.

Distillation of policy improvement tips with trajectory contrasting may be another type of knowledge. According to exemplary aspects, distillation of select knowledge may enhance good behaviors (e.g., those that may incur high long-term reward) and avoid undesired behaviors in the task distribution. In this regard, aspects of the present disclosure are directed to distillation of policy improvement tips, which indicate what actions may be preferred under different circumstances. However, with offline data that only provide sequence of interactions and final scores, it may be non-trivial for an LLM to figure out the correct credit assignment and the useful tips to guide policy improvement. To this end, distillation of trajectory contrasting is proposed. According to exemplary aspects, the distillation of trajectory contrasting may include sampling of both successful (score above a reference threshold) and failed (score below a reference threshold) trajectories and generating tips via the LLM agent by contrasting the successful and failed trajectories. FIG. 4B may illustrates the distillation of the policy improvement tips with trajectory contrasting with a distil prompt, which iteratively updates an LLM powered policy.

As illustrated in FIG. 4C, an LLM-powered policy (π) for sequential decision-making may be a function that maps the interaction history to a distribution over actions. For example, when π(a|τ) denotes the probability of selection action a given interaction history τ, which may refer to a sequence of all past observations and actions (o₁, a₁, o₂, a₂, . . . , oₜ). Then, with a pre-trained LLM, the LLM policy may be realized in two ways, namely a text-based policy and a code-based policy.

According to exemplary aspects, with a pre-trained LLM which outputs text based on any input (i.e., text-based policy), the text-based policy may be written as:

πₜₑₓₜ(a|τ):=LLM(a|τ;θₚₘₜ,θₚᵣₑₜ)

Here, a may refer to a task of going to fridge 1. θₚₘₜ may refer to a prompt provided according to a text-based policy, which may provide a general instruction (e.g., “Interact with the environment to solve a task”), provide examples (e.g., “Here are some examples: (examples)”) and provide a specific task (e.g., “Here is your task: (task_description)”).

According to exemplary aspects, LLM may be programmed, such that one may ask the LLM to directly generate code to implement a policy function (i.e., code-based policy). The code-based policy may be written as:

Π_{code}(a|τ):=Code(a|τ)←LLM(θₚₘₜ,θₚᵣₑₜ).

Here, Code(a|τ) provides a definition of policy based on history (e.g., “def policy (history)”. Further, θₚₘₜ may generate code to interact with an environment and solve a task, provide examples, and provide a specific task to be performed.

According to exemplary aspects, the goal of the LLM may be to learn a policy that may maximize the total reward. In both of the above noted policies, the pre-trained LLM weights θₚᵣₑₜ may be fixed, and the O3D platform may learn a policy by learning and optimizing the base prompt θₚₘₜ as well as the written policy code Code(a|τ) from the offline data.

Moreover, a policy may be conditioned on specific skills or subgoals (e.g., find a mug), which may be compositional factors of the original task (e.g., heat some milk), for providing a skill-conditioned policy. In an example, when a variable z represents a skill, then a skill-conditional policy may be denoted as π^{z}, with π^{z}(a|τ) the probability of selection action a given history t when executing skill z.

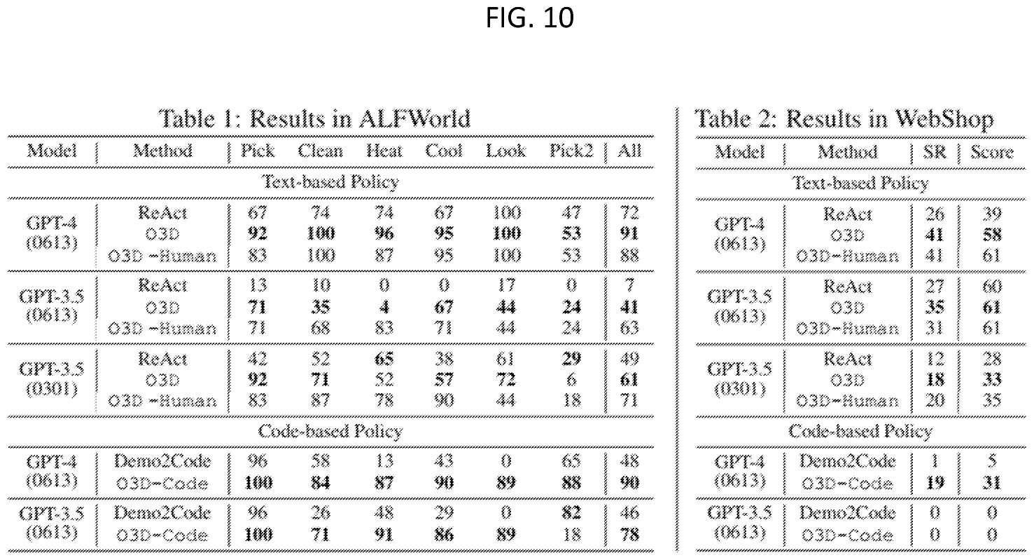

According to exemplary aspects, the O3D framework may automatically discover reusable skills and distill generalizable knowledge across multiple tasks based on offline interaction data, advancing the capability of solving downstream tasks. Empirical results under two interactive decision-making benchmarks (e.g., ALFWorld and WebShop) as illustrated in FIG. 10 demonstrate that O3D may notably enhance the decision-making capabilities of LLMs through the offline discovery and distillation process, and consistently outperform baselines across various LLMs with both text based policy and code based policy.

According to exemplary aspects, an offline learning framework may be configured to enable LLMs to discover and distill useful knowledge from interaction trajectories on multiple tasks. In this regard, LLM-policies may unify two parallel approaches generating text and code as policies, respectively. For these LLM-powered policies, O3D may be iterated over offline dataset for continually improving the LLM policy. In this regard, the O3D framework may not require a high-quality expert offline dataset, as it may benefit from both positive examples and negative examples of environment interactions, making the framework easier and cheaper to use in in practice.

### Third Stage

According to exemplary aspects, the third stage may be directed to composing the policies and interacting with the downstream tasks by calling the learned policies. More specifically, the third stage constructs the interactive policy by calling the learned skills given the diverse tasks. More specifically, the third stage may be utilized to construct the main LLM-powered autonomous agent that is able to reason and call corresponding skills sequentially to solve given tasks.

FIG. 4D illustrates construction of the LLM agent based on the skill-conditioned policies obtained from the previous two stages. According to exemplary aspects, the LLM agent adopts a base policy, which is prompted to call proper skill-conditioned policies sequentially given any downstream task. For example, an environment may provide a task instruction to the LLM agent, which in response may call skill-conditioned policies in a sequential order. Each of the called skilled-conditioned policy will in turn make primitive observations and perform primitive tasks for the respective skilled-conditioned policy.

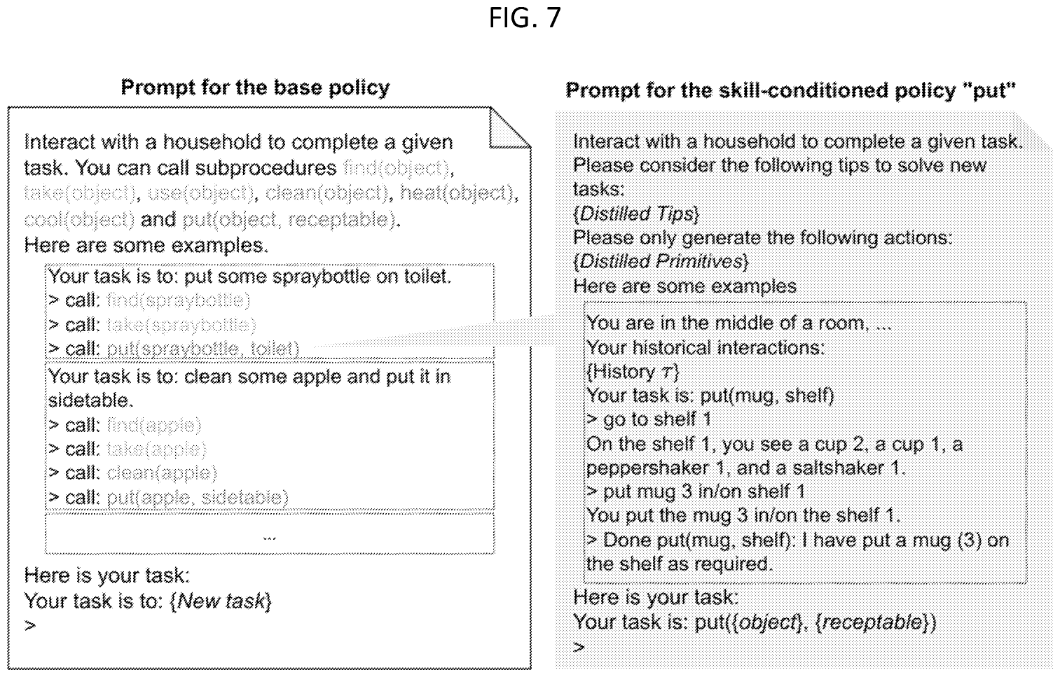

According to exemplary aspects, a base policy π_{base} may be prompted with a few examples on calling the proper skills sequentially given a downstream task. The referenced examples may be from LLM's segmentation of offline trajectories. FIG. 7 illustrates an example of how to construct the base policy by prompting and how a skill-conditioned policy is prompted when being called. More specifically, FIG. 7 illustrates exemplary prompts for the base policy and the text-based skill conditioned policy for hierarchical policy execution in the third stage.

As shown in FIG. 7, the prompt for the base policy may provide instructions to interact with a household to complete a given task. The prompt may also provide a listing of sub-procedures or function objects that may be called, including find(object), take(object), use(object), clean(object), heat(object), cool(object) and put(object, receptacle). However, aspects of the present disclosure are not limited thereto, such that additional sub-procedures and or function objects may be available and/or listed. In addition to the above, the prompt may additionally provide examples of a task that interacts with a household and corresponding sub-procedures of function objects. As shown in FIG. 7, an example of a task of putting some spray bottle on a toilet may include sequential calling of the find (spray bottle) sub-procedure, followed by take (spray bottle) and put (spray bottle, toilet) sub-procedures, where the spray bottle is the object, and the toilet is the receptacle. Another example of a task of cleaning some apple and putting it on a side table may include sequential calling of the find (apple) sub-procedure, followed by take (apple) sub-procedure, further followed by the clean (apple) and put (apple, side table) sub-procedures, where the apple is the object, and the side table is the receptacle. Following such prompt, a new task is specified.

As illustrated in more detail on the right hand side of FIG. 7, a prompt for the skilled condition policy of the “put” sub-procedure or function object is provided. In the prompt for the respective skilled condition policy, distilled tips may be provided for the tasks, and distilled primitives may be generated for the actions. Examples provided may specify an environment (middle of a room) and historical interactions (history t). Task of putting a mug on a shelf is identified (put (mug, shelf)), which includes an action of going to shelf 1, and on the shelf 1, seeing a cup 2, cup1, a peppershaker 1, and a saltshaker 1. This action is subsequently followed by an action of putting mug 3 in/on shelf 1, which is further acknowledgement of completion of the specified task (putting the mug 3 on the shelf as required.

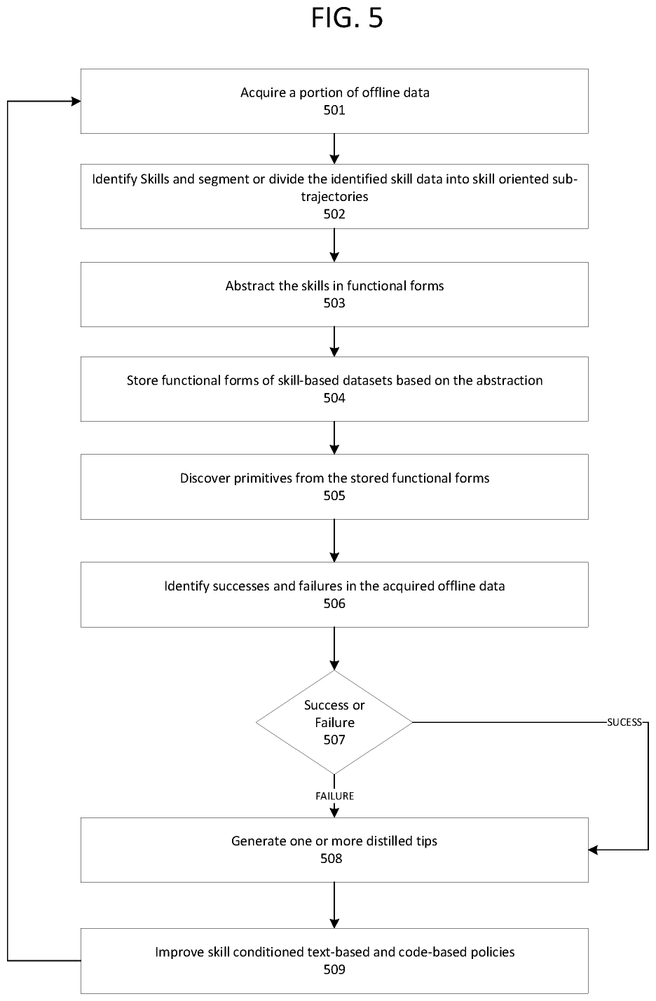

FIG. 5 illustrates a method for constructing a skill-conditioned policy using an O3D platform in accordance with an exemplary embodiment.

According to exemplary aspects, FIG. 5 may be directed to establishing offline in-context learning framework for LLM sequential decision-making agents, such that the LLM is capable of learning from offline experience without requiring any finetuning. This offline learning paradigm may allow more effective usage of past interactions (including both good and bad behaviors) generated by human or other agents (e.g., interactive voice response (IVR)), alleviating technical resource expenditure required for performing online learning as conventionally done.

Moreover, offline learning algorithm may unify two approaches, namely the text action generation and code generation, which are typically performed separately. Further, different from conventional practices, which prompts and solves different types of tasks differently, O3D algorithm is capable of leveraging offline experiences from multiple tasks and allow LLMs to automatically distill shared high-level knowledge. Accordingly, the O3D algorithm may be able to achieve few-shot generalization to various types of tasks with a single set of prompts.

In operation 501, a portion of offline data may be acquired. According to exemplary aspects, offline data may include, without limitation, historical interaction histories or logs. The historical interaction histories or logs may include tasks including several sub-tasks. The sub-tasks may be environment specific. Historical interaction histories or logs may include interactions with a human agent. However, aspects of the present disclosure are not limited thereto, such that the historical interaction histories or logs may include interactions with automated systems or other agents/systems.

In operation 502, one or more skills are identified from the acquired portion of the offline data. According to exemplary aspects, skills may be directed to performing a specific function, such as finding operation, taking operation, putting operation and the like. The identified skills are then segmented or divided into skill oriented sub-trajectories. For example, data directed to a skill of find operation may be grouped together, and data directed to a skill of taking operation may be grouped together. Remaining data that may not correspond to any particular skill may be deleted from memory to increase memory availability and improve memory or storage utilization.

In operation 503, each of the grouped data corresponding to a particular skill may be abstracted into a functional form, which may be reusable in various tasks requiring such skill. For example, a find function, a put function, a take function and the like may be provided by the abstraction. According to exemplary aspects, each of the functional forms may be handled or executed by a separate autonomous agent. For example, an autonomous agent may be set to execute the find function, and another autonomous agent may be set to execute the take function. However, aspects of the present disclosure are not limited thereto, such that an autonomous agent may be able to execute multiple functions.

In operation 504, the functional forms (e.g., find function) of skill-based datasets based on the abstraction may be stored on a database, such that such functions may be called for performing a task or sub-task requiring the stored function.

In operation 505, from the stored functional forms, one or more primitives are discovered. For example, the primitives may specify specific action performed with respect to a subject type (e.g., location, object, tool, receptacle and the like). One primitive may specify “go to [loc]”, and another primitive may specify “clean [obj] with [too]”. As the actions are genericized, such actions may be reused in different environments, where specific subject may be specified for the place holders.

In operation 506, successfully performed tasks and failed tasks may be identified from the offline data. For example, a failed tasks may include an interaction where a user has to repeat his or choice, indicates that an action performed by an agent is incorrect or based on frustration by the user. However, aspects of the present disclosure are not limited thereto, such that a tasks may be deemed to be successfully performed or not based on different attributes or metrics.

Unlike conventional training mechanism, where only the successfully performed tasks, many times by an exemplary expert, are provided to an autonomous agent, exemplary aspects of the present disclosure utilizes the offline data without removal of the failed interactions. Instead, the failed transactions are fed to the O3D system for distilling tips to avoid such failures from future transactions. Accordingly, no pre-processing of input data is required in this regard. Moreover, no hand selection of input data is necessary, leading to computational efficiencies.

In operation 507, the transactions identified as being successful proceeds to operation 508 for validation of correct actions taken for distilling tips for successful outcome. Alternatively, the transactions identified as being failures also proceeds to operation 508, but to distill tips from performing similar actions that led to such failures in the future.

In operation 509, the discovered primitives and the distilled tips are utilized to modify or improve existing policies to provide a skill conditioned text-based policy and a skill conditioned code-based policy. According to exemplary aspects, the discovered primitives and/or the distilled tips may be utilized to improve policies with respect to each skill. Once operation 509 is completed for the portion of the offline data acquired in operation 501, the method starts back at operation 501 with a different portion of the offline data. According to exemplary aspects, operations of method of FIG. 5 is iteratively performed using the offline data to continually improve the skill-conditioned policies.

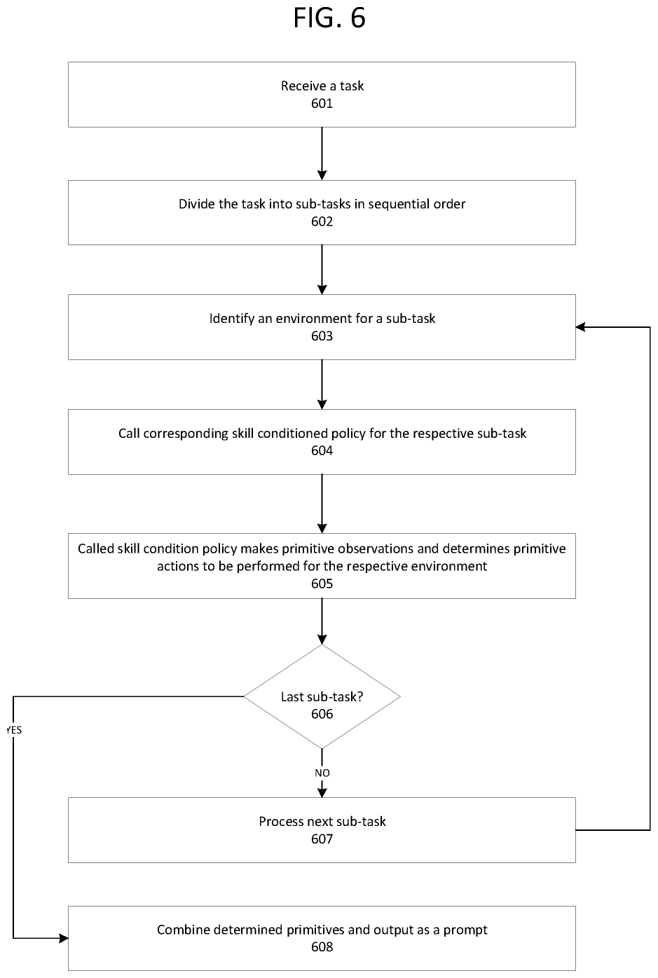

FIG. 6 illustrates a method for providing a prompt for performing a task using a skill-conditioned policy in accordance with an exemplary embodiment.

In operation 601, a task for performance is received. According to exemplary aspects, the task for performance may include multiple sub-tasks with different environments, requiring sequential performance. For example, a task may be to putting an apple on a side table.

In operation 602, a central LLM agent trained using offline data in O3D platform divides the task into sub-tasks in sequential order. Each of the identified sub-tasks may be processed at a time. In the above noted task example, sub-tasks may include finding an apple, taking the apple to the side table, and putting the apple on the side table.

In operation 603, the central LLM agent may identify an environment for a corresponding sub-task. For example, environment may be a countertop on which an apple is found.

In operation 604, the central LLM agent calls a corresponding skill conditioned policy for the respective sub-task. According to exemplary aspects, separate autonomous agents may handle the separate skill conditioned policies. For example, an autonomous agent 1 may be called to execute skill condition policy for the find skill, while an autonomous agent 2 may be called to execute a skill condition policy for the take skill.

In operation 605, the autonomous agent called for the respective skill conditioned policy makes primitive observations and determines primitive actions to be performed for the respective environment.

In operation 606, a determination of whether the last sub-task of the task is performed is rendered. If the respective sub-task process is not the last sub-task from the task, the method proceeds to operation 607 for processing the next sequential sub-task for the respective task, and subsequently proceeds back to operation 603.

On the other hand, if the sub-task processed is the last sequential sub-task of the respective task, then the method proceeds to operation 608. In operation 608, the determined primitives for the processed sub-tasks are combined and output by the central LLM agent.

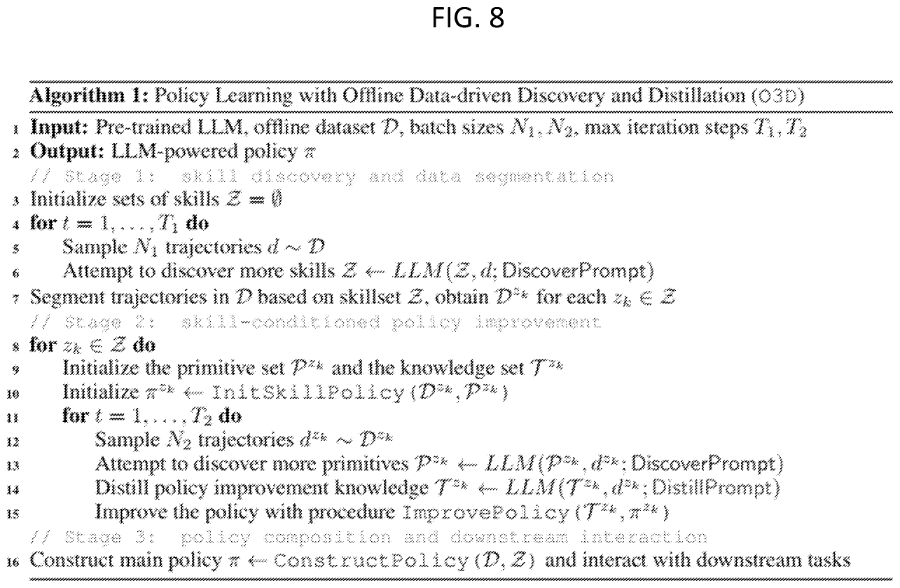

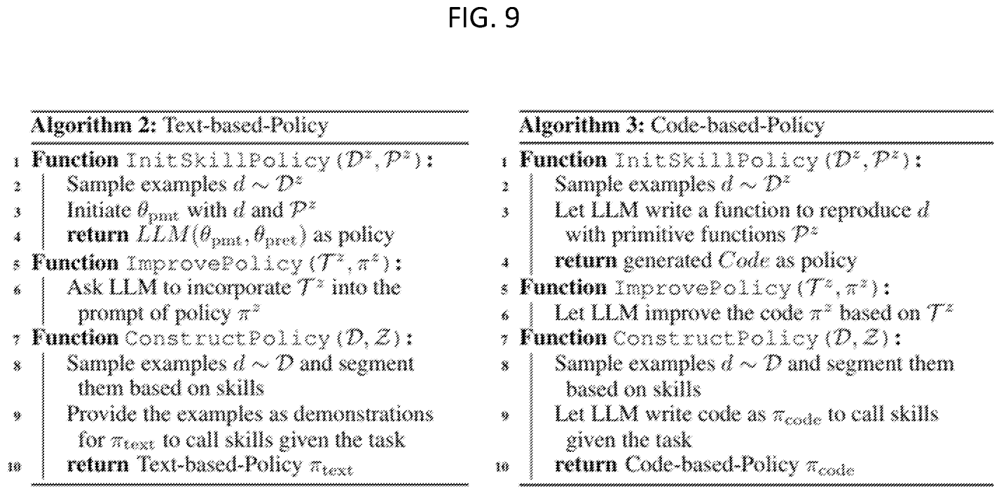

FIG. 8 illustrates an algorithm for policy learning with O3D in accordance with an exemplary embodiment. FIG. 9 illustrates algorithms for implementation specific functions for text-based policy and code-based policy in accordance with an exemplary embodiment.

According to exemplary aspects, algorithm 1 of policy learning with O3D is presented in FIG. 8. Implementation-specific functions for text-based policy and code-based policy are defined in algorithm 2 and 3 presented in FIG. 9. According to exemplary aspects, several differences in implementation between the text-based policy and the code-based policy may exist, and such differences may include the policy formulation and improvement processes.

With respect to policy initialization with primitives, the text-based policy may directly provide the discovered primitives in the prompt of policy and advise the LLM agent to follow the primitives. In contrast, the code-based policy may first let the LLM agent write primitive functions and then calls these primitive functions in the code of skill-conditioned policies.

With respect to policy improvement, since the distilled policy improvement tips are in natural language, the LLM may be instructed to merge the new suggestion into the prompt of text-based policy. For code-based policy, the LLM may consider the policy improvement tips and re-write each skill-conditioned policy code.

With respect to policy construction and execution, in the third stage, the base policy may be prompted to call the learned text-based policy or the code-based policy. For the code-based policy, it may be possible that the generated skill-conditioned code may have compilation errors, which may require additional checking or validation on a small set of tasks to verify that the code is executable.

Conventionally, use of LLMs to directly interact with environments (text-based policy) and using LLMs to write code to interact with environments (code-based policy) are usually discussed separately. According to exemplary aspects, however, the two policies are unified and compared against in a single framework.

According to exemplary aspects, code-based policy explicitly writes the acting policy in code, which may be more interpretable and reliable, and may fully avoid hallucinations or syntax errors in execution. Moreover, code-based policy may be more cost efficient, as the generated code may be reused in new tasks without calling LLMs. Therefore, code-based policy may be more suitable for applications where reliability and efficiency may be important.

According to exemplary aspects, text-based policy may be relatively easy to implement in practice with less human supervision. Also, in complicated environments, such as WebShop, where language understanding is important, text-based policy may achieve better performance than the code-based policy, as it retains common sense, expressiveness and reasoning ability of pre-trained LLMs. Therefore, for language-oriented applications where reasoning and the ability of recovering from failure are crucial, text-based policy, or a combination of the two approaches, may be a better choice.

FIG. 10 illustrates results for comparative testing between different methods for performing tasks in two sequential decision-making benchmarks in accordance with an exemplary embodiment.

According to exemplary aspects, two sequential decision-making benchmarks, ALFWorld and WebShop, are considered for evaluation of the O3D framework. ALFWorld may refer to a unique environment that mimics household scenarios and allows a decision-making agent to interact with the environment through a text-based interface. For purposes evaluation, 134 tasks across six distinct tasks types are considered. Further, horizon of each episode was limited to 30 steps and the episode is set to terminate when the agent takes the same action twice.

WebShop, on the other hand, provides a real-world online shopping environment with 1.18 million products, where an agent must explore the website, check relevant product candidates, and purchase the one that matches user instruction (e.g., “I am looking for a queen sized bed that is black, and price lower than 140.00 dollars”). Evaluation results illustrated in FIG. 10 considers the first 50 out of 12,087 instructions as a test set.

The proposed O3D and O3D-code are compared against popular text-based baseline method, ReAct, and a state-of-the-art code-based baseline approach, Demo2code. Further, a variant of the O3D framework is also considered, namely, O3D-Human, which utilizes knowledge summarized by a human from the logs of ReAct in the test set of each domain, which may serve as a baseline. The above described experiment design illustrate whether improvement tips distilled by LLMs are as effective as the tips distilled by humans. In ALFWorld, method performance is assessed by measuring the success rate (SR) under each task type as well as a total success rate over 134 tasks. Besides the success rate in WebShop, a product matching score is additionally provided.

In order to investigate the robustness of O3D across various LLMs, three GPT models, which provide different θₚᵣₑₜ, were considered in the experiments of FIG. 10. The offline data may include official human demonstrations in both domains as success data, and a set of failure data generated using ReAct on the training task set introduced in the original ALFWorld and Web Shop implementations.

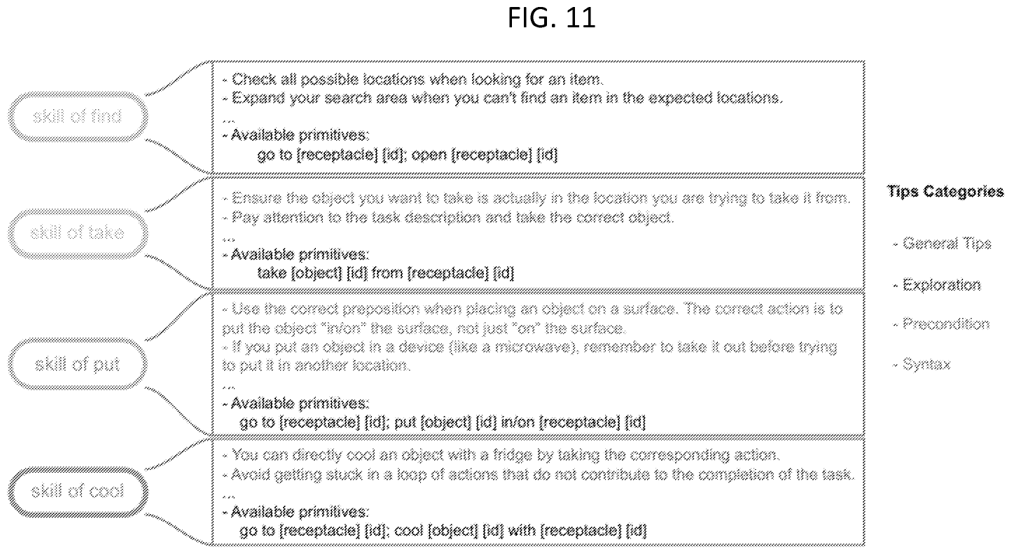

FIG. 11 illustrates examples of discovered skills with primitives and distilled knowledge under a sequential decision-making benchmark in accordance with an exemplary embodiment.

As illustrated in FIG. 11, experiments in two commonly used domains, namely ALFWorld and WebShop, show that LLM augmented by offline knowledge under the O3D platform has better few-shot performance than prior methods on a variety of downstream tasks. In the experiments of FIG. 11, O3D efficiently extracts high-quality skills from raw human demonstrations in the offline data, resulting in seven types of skills under ALFWorld domain, including: find(object), take(object), put(object, receptacle), cool(object), heat(object), use(object) and clean(object). Further, four types of skills under WebShop domain were identified, including search item, select item, select item's attributes and purchase item. However, aspects of the present disclosure are not limited thereto, such that different or additional types of skills may be identified. According to exemplary aspects, each skill may include a set of primitives to execute, along with a group of tips to assist with the skill completion.

As illustrated in FIG. 11, several skill examples in ALFWorld domain are indicated, namely, the skill of find, the skill of take, the skill of put and the skill of cool. By learning from offline data, O3D may be able to capture correct primitives that may be composed to achieve each corresponding skill. Moreover, tips distilled by O3D may be functional to various degrees, such as suggesting general tips, encouraging exploration, realizing action preconditions and highlighting syntax.

For example, for the skill of find, tips distilled by O3D may include (i) checking for all possible locations when looking for an item, and (ii) expanding a search area when an item can't be found in the expected locations. The skill of find may additionally include primitives of go to [receptacle] [id], and open [receptacle] [id]. The other skills of take, put and cool may also include one or more tips distilled by O3D along with corresponding primitives.

As illustrated in FIG. 11, O3D is indicated as consistently outperforming baselines in both the text-policy and the code-based policy across various LLMs in the ALFWorld domain and the WebShop domain. As shown in FIG. 11, when using LLMs as text-based policies, O3D respectively outperformed ReAct by 19%, 34% and 12% in ALFWorld, and 15%, 8% and 6% in WebShop in terms of success rate, with using GPT-4-0618, GPT-3.5-0613 and GPT-3.5-0301, respectively. Moreover, as further shown in FIG. 11, success rate achieved by O3D under each task category is consistently greater than the one achieved by ReAct with GPT-4-0613 and GPT-3.5-0613. Such evidence confirms that the tips distilled by O3D from offline data is generalizable and useful across diverse task types.

For example, the tip of “pay attention to the task description and take the correct object” helps the LLM agent avoid taking a similar object (a pot) rather than the requested one (a pan), and the tip of “[t]he correct action is to put the object ‘in/on’ the surface, not just ‘on’ the surface” prevents the LLM agent from using wrong syntax of primitives. Further, O3D may achieve competitive performance with O3D-Human in both domains, and even surpass O3D-Human when using GPT-4 in ALFWorld and GPT-3.5-0613 in WebShop. Such evidence may validate O3D's knowledge distillation may competently and autonomously extract reliable tips from offline data to enhance capability of an LLM to solve downstream tasks without finetuning, which may require computationally intensive prompt engineering. Accordingly, O3D platform may autonomously and reliable extract tips without finetuning, leading to improved computational efficiency, such that computing resources may be conserved.

As further illustrated in FIG. 11, in ALFWorld, O3D-Code surpasses Demo2Code, achieving a 32% higher performance with GPT-4-0613 and 14% higher performance with GPT-3.5-0613. Additionally, 18% performance improvement on Web Shop tasks using GPT-4-0613 was observed. An advantage of the O3D platform is its unique method of generating code, namely, adaptation of a bottom-up style, which effectively constructs policies on top of robust skill functions. Through iterative skill refinement, functions may then be efficiently utilized and reused to compose higher-level policies. In contrast, Demo2Code follows a top-down approach, requiring the generation of code for the same set of skills each time it receives new task. Due to the context length constraint inherent in LLMs, only a limited number of demonstrations may be used to guide skill code generation in Demo2Code, resulting in unstable and inconsistent skills.

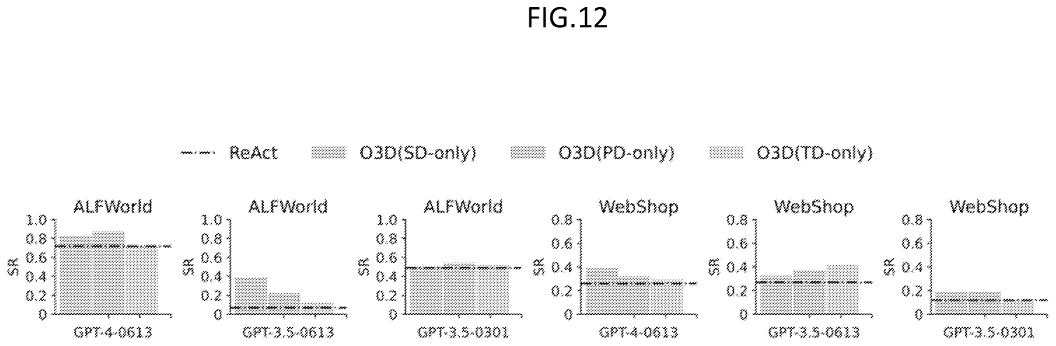

FIG. 12 illustrates a comparison of success rates with three variants of O3D against a baseline method in accordance with an exemplary embodiment.

As illustrated in FIG. 12, primitives, skills and policy improvement tips independently advance baseline performance in both ALFWorld and WebShop. According to exemplary aspects, O3D may include three major processes: skill discovery (SD), primitives discovery (PD) and policy improvement tip distillation (TD). FIG. 12 exemplarily illustrates each component's contribution to performance in downstream task solving, with respect to three variants of O3D, each with only one component. FIG. 12 illustrates that, in both domains, the three variants of O3D either outperform the baseline or achieve similar performance as the baseline across tested LLM models. In ALFWorld, O3D (PD-only) plays the dominant role in performance improvement with GPT-4-0613 and GPT-3.5-0301. This is because the major mistakes made by the baseline are in terms of outputting primitive actions with syntax errors or hallucinating unavailable actions. O3D (SD-only) boost the performance the most with GPT-3.5-0613, because the tasks in ALFWorld may be too complex for ReAct with GPT-3.5-0613, and O3D (SD-only) solves the tasks in hierarchy by performing skill selections that greatly reduces the complexity. In WebShop, the three components consistently benefit the baseline performance across the three GPT models, with their individual contributions also being model dependent. Since the offline data was collected using GPT-3.5-0613, highest overall improvement of the three components is observed to occur in this model.

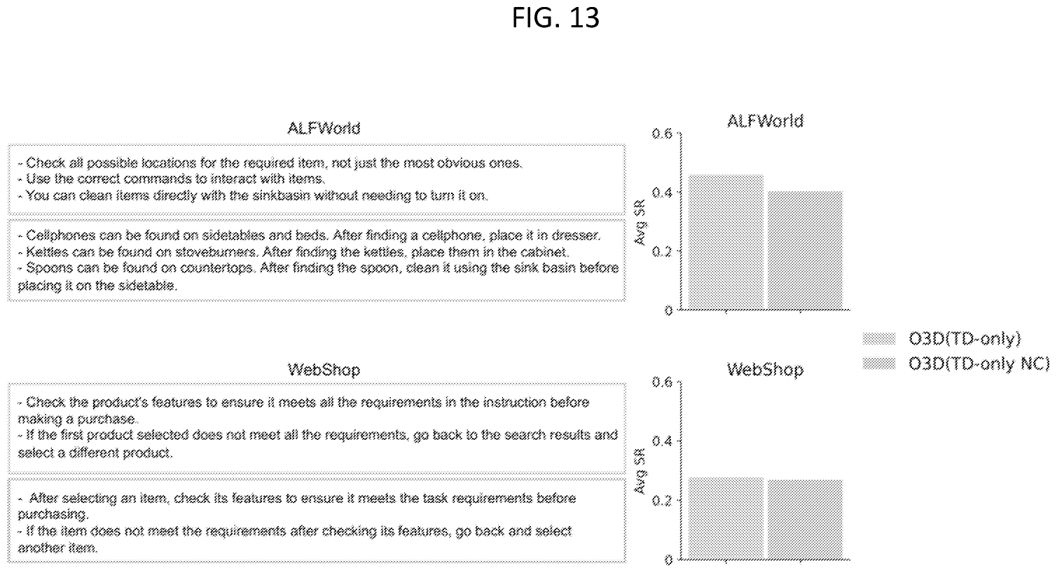

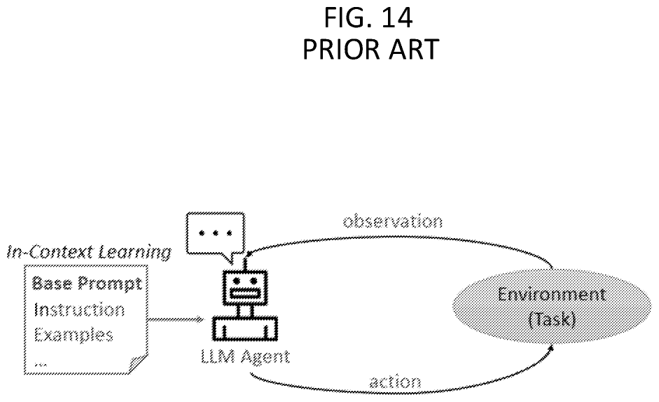

FIG. 13 illustrates a comparison on averaged success rate over LLM models between using tips distilled via contrastive and non-contrastive methods in accordance with an exemplary embodiment.

FIG. 13 exemplarily illustrates advantages of using a contrastive method to distill improvement tips versus a non-contrastive (NC) method is domain-dependent. FIG. 13 shows that the proposed trajectory contrasting, which compares both successful and failed trials in offline data, is relatively helpful in certain domains, compared with the non-contrastive way based on only success data. In ALFWorld, failures in baseline method are often caused by violations of the domain-specific dynamics and rules. Therefore, the contrastive approach may generate general tips to correct mistakes that occur in failure cases, while the non-contrastive approach only summarizes the facts from successful trials, which may be less helpful. However, in WebShop, the two approaches achieve similar performance, as they output analogous tips as shown in the corresponding boxes in FIG. 13.

According to exemplary aspects, an offline in-context learning framework, O3D, is provided for LLM sequential decision making agents, where agents can learn from previous experiences in a scalable offline manner to improve performance without the need for fine tuning. O3D stands out by allowing LLMS to distill shared high-level knowledge from offline interaction logs, which may be injected into a single set of prompts to be reused in solving diverse downstream tasks. Further, O3D leverages a unified algorithm that enhances both text-based policies and code-based policies with LLMs, outperforming baseline methods in two challenging benchmark domains.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a task requiring a plurality of sequential decision-making operations by an autonomous agent, the method comprising:
acquiring, by a processor and from a database, a portion of offline data;
identifying, by the processor and from the portion of the offline data, skills data corresponding to a plurality of skills;
segmenting, by the processor, the skills data into a plurality of skill oriented sub-trajectories corresponding to the plurality of skills;
abstracting, by the processor, the plurality of skills into a plurality of reusable functions;
storing, by the processor and in a memory, the plurality of reusable functions;
discovering, from the memory, one or more primitives for each of the plurality of reusable functions;
identifying, by the processor and from the portion of the offline data acquired, at least one successfully completed task interaction and at least one failed task interaction;
generating, by the processor, at least one or more distilled tips based on the at least one successfully completed task interaction and the at least one failed task interaction;
modifying, by the processor, a skill-conditioned text based policy and a skill-conditioned code-based policy;
augmenting, by the processor and using the modified skill-conditioned text based policy and the modified skill-conditioned code-based policy, the autonomous agent;
receiving, by the processor for execution by the autonomous agent, a new task requiring a plurality of sequential decision-making operations by the autonomous agent; and
completing, using the augmented autonomous agent, a new task requiring a plurality of sequential decision-making operations.

2. The method according to claim 1, wherein the completing of the new task comprises:
dividing, by the augmented autonomous agent, the new task into a plurality of sub-tasks for execution in sequential order;
identifying, by the augmented autonomous agent and for each of the plurality of sub-tasks, an environment;
calling, by the augmented autonomous agent and among the modified skill-conditioned text based policy and the modified skill-conditioned code-based policy, at least one skill conditioned policy corresponding to a sub-task;
performing, by the augmented autonomous agent, at least one primitive observation for the environment corresponding to the sub-task; and
determining, by the augmented autonomous agent, at least one primitive action for the environment corresponding to the sub-task.

3. The method according to claim 2, further comprising:
determining, by the augmented autonomous agent, whether the sub-task is a last sub-task among the plurality of sub-tasks; and
when the sub-task is determined not to be the last sub-task, processing another sub-task that sequentially follows the sub-task.

4. The method according to claim 2, further comprising:
determining, by the augmented autonomous agent, whether the sub-task is a last sub-task among the plurality of sub-tasks; and
when the sub-task is determined to be the last sub-task:
combining, by the augmented autonomous agent, the at least one primitive observation and the at least one primitive action; and
outputting, by the augmented autonomous agent, an output including a combination of the at least one primitive observation and the at least one primitive action.

5. The method according to claim 1, wherein the autonomous agent is a large language model.

6. The method according to claim 1, wherein training of the autonomous agent is not required.

7. The method according to claim 1, wherein the offline data is a historical interaction log.

8. The method according to claim 7, wherein the historical interaction log is with a human agent.

9. The method according to claim 1, wherein the offline data includes both a successfully completed task transaction and a failed task transaction.

10. The method according to claim 1, wherein one or more of the plurality of reusable functions are executed by one or more skill-specific autonomous agents.

11. The method according to claim 1, wherein at least one of the one or more skill-specific autonomous agents is a large language model agent.

12. The method according to claim 1, wherein the new task is completed without fine tuning the augmented autonomous agent.

13. The method according to claim 1, wherein the output is provided as a text prompt.

14. The method according to claim 1, wherein the one or more of the plurality of reusable functions includes a find function, a take function, a put function, a cool function, a heat function, a use function and a clean function.

15. The method according to claim 1, wherein the at least one or more distilled tips includes a tip that indicates what action is preferred under different circumstances.

16. The method according to claim 1, wherein the at least one or more distilled tips includes a tip that enhances a desired behavior.

17. The method according to claim 1, wherein the at least one or more distilled tips includes a tip that discourages an undesired behavior.

18. The method according to claim 1, wherein the at least one primitive action includes an action with a place holder for a subject.

19. A system for performing a task requiring a plurality of sequential decision-making operations by an autonomous agent, the system comprising:
a memory; and
a processor,
wherein the system is configured to perform:
acquiring, from a database, a portion of offline data;
identifying, from the portion of the offline data, skills data corresponding to a plurality of skills;
segmenting the skills data into a plurality of skill oriented sub-trajectories corresponding to the plurality of skills;
abstracting the plurality of skills into a plurality of reusable functions;
storing the plurality of reusable functions;
discovering one or more primitives for each of the plurality of reusable functions;
identifying, from the portion of the offline data acquired, at least one successfully completed task interaction and at least one failed task interaction;
generating at least one or more distilled tips based on the at least one successfully completed task interaction and the at least one failed task interaction;
modifying a skill-conditioned text based policy and a skill-conditioned code-based policy;
augmenting, using the modified skill-conditioned text based policy and the modified skill-conditioned code-based policy, the autonomous agent;
receiving, for execution by the autonomous agent, a new task requiring a plurality of sequential decision-making operations by the autonomous agent; and
completing, using the augmented autonomous agent, a new task requiring a plurality of sequential decision-making operations.

20. A non-transitory computer readable storage medium that stores a computer program for performing a task requiring a plurality of sequential decision-making operations by an autonomous agent, the computer program, when executed by a processor, causing a system to perform a plurality of processes comprising:
acquiring, from a database, a portion of offline data;
identifying, from the portion of the offline data, skills data corresponding to a plurality of skills;
segmenting the skills data into a plurality of skill oriented sub-trajectories corresponding to the plurality of skills;
abstracting the plurality of skills into a plurality of reusable functions;
storing the plurality of reusable functions;
discovering one or more primitives for each of the plurality of reusable functions;
identifying, from the portion of the offline data acquired, at least one successfully completed task interaction and at least one failed task interaction;
generating at least one or more distilled tips based on the at least one successfully completed task interaction and the at least one failed task interaction;
modifying a skill-conditioned text based policy and a skill-conditioned code-based policy;
augmenting, using the modified skill-conditioned text based policy and the modified skill-conditioned code-based policy, the autonomous agent;
receiving, for execution by the autonomous agent, a new task requiring a plurality of sequential decision-making operations by the autonomous agent; and
completing, using the augmented autonomous agent, a new task requiring a plurality of sequential decision-making operations.
